(19) United States
(12) Patent Application Publication
(10) Pub. No.: US 2015/0096416 A1
(43) Pub. Date: Apr. 9, 2015

(54) Cover Kit for Portable Electronic Device

(71) Applicant: Michael Kidakarn, Gardena, CA (US)

(72) Inventor: Michael Kidakarn, Gardena, CA (US)

(21) Appl. No.: 14/049,166

(22) Filed: Oct. 8, 2013

(51) Int. Cl. B26F 1/40; B26F 1/44; B44C 1/16

(52) U.S. Cl. CPC B26F 1/40; B44C 1/16; B26F 1/44; B26F 2001/4481
USPC 83/613; 156/256

(57) ABSTRACT

A cover kit for a portable electronic device includes a cover unit and a stamp unit. The cover unit has a transparent panel, a plurality of side boundary walls peripherally extended from the transparent panel to define a receiving cavity between the transparent panel and the side boundary walls, wherein the receiving cavity is shaped and sized to fitly and detachably receive the portable electronic device. The stamp unit is adapted for cutting a predetermined printed material to form an aesthetic pattern sheet, wherein the aesthetic pattern sheet has a predetermined aesthetic pattern formed thereon, and is adapted for accommodating on the receiving cavity in such a manner that the aesthetic pattern is capable of being observed from the transparent panel.

### BACKGROUND OF THE PRESENT INVENTION

1. Field of Invention

The present invention relates to a cover kit, and more particularly to a cover kit for a portable electronic device, wherein the cover kit is capable of allowing a user to conveniently select and adopt a predetermined aesthetic patterns on a cover body.

2. Description of Related Arts

Users of portable electronic devices, such as smart phones, usually purchase an external cover to partially or fully embed the portable electronic devices in an attempt to protect the devices from external impacts or stretches. One of the main disadvantages the aesthetic patterns of the external covers are usually pre-set and fixed, with no possibility of being changed unless the user purchase another cover with different aesthetic pattern.

Recently, external covers as described above have become a kind of fashion along users of portable electronic devices. Thus, many people want his or her external cover to bear the aesthetic pattern of popular characters. For example, they may purchase an external cover with a famous basketball star printed thereon. However, because such famous or popular characters, patterns are usually subject to copyright protection, the license fee is included in the purchase price of the external cover and this makes the overall price of the external cover very expensive.

As a result, when the user wishes to purchase another external cover because of a newly released aesthetic pattern or he becomes blasé about the old aesthetic pattern printed on the old external cover, the user needs to spend a considerable amount money.

When the user wishes to use external covers of different patterns, he or she needs to purchase many external covers. More importantly, the user may not fully like a particular portion of the aesthetic pattern. However, because all the designs of the aesthetic patterns are pre-set and pre-printed on the external cover, the user has no choice but to purchase it. This practice involves considerable waste of money and resources.

### SUMMARY OF THE PRESENT INVENTION

The invention is advantageous in that it provides a cover kit for a portable electronic device, such as a smart phone, wherein the cover kit is capable allowing a user to conveniently select and adopt a predetermined aesthetic pattern on a cover body.

Another advantage of the invention is to provide as a cover kit a portable electronic device, wherein the cover kit comprises a cover unit having a transparent panel for allowing a user to accommodate a predetermined aesthetic pattern sheet onto the transparent panel so as to alter aesthetic appearance of the cover kit corresponding to the aesthetic pattern printed on the aesthetic pattern sheet.

Another advantage of the invention is to provide as a cover kit for a portable electronic device, wherein the cover kit comprises a cutting device arranged to cut the aesthetic pattern sheet in such a manner that the aesthetic pattern sheet can be fitly accommodated on the transparent panel of the cover unit. Thus, a user of the present invention may be able to freely cut his or her desirable aesthetic pattern by using the cutting device.

Another advantage of the invention provide as a cover kit for a portable electronic device, wherein the cover kit does not involve expensive equipment and complicated method for producing the aesthetic pattern sheet.

Another advantage of the invention is to provide as a cover kit for a portable electronic device, wherein the cover kit utilizes an existing printed material, such as a magazine, to produce the aesthetic pattern sheet. In other words, the user of the present invention does not need to pay extra copyright licensing fee for accommodating the printed material onto the cover unit, because the user does not copy anything from a legitimate source of printed materials.

Another advantage of the invention is to provide a method of producing an aesthetic pattern on a cover unit, wherein the user is able to conveniently and freely accommodate a desirable aesthetic pattern sheet onto a cover unit.

Additional advantages and features of the invention will become apparent from the description which follows, and may be realized by means of the instrumentalities and combinations particular point out in the appended claims.

According to the present invention, the foregoing and other objects and advantages are attained by providing a cover kit for a portable electronic device, comprising;

a cover unit having a transparent panel, a plurality of side boundary walls peripherally extended from the transparent panel to define a receiving cavity between the transparent panel and the side boundary walls, wherein the receiving cavity is shaped and sized to fittedly and detachably receive the portable electronic device; and

a stamp unit adapted for cutting a predetermined printed material to form an aesthetic pattern sheet, wherein the aesthetic pattern sheet has a predetermined aesthetic pattern formed thereon, and is adapted for accommodating on the receiving cavity in such a manner that the aesthetic pattern is capable of being observed from the transparent panel.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of a cover kit according to a preferred embodiment of the present invention.

FIG. 2 is a perspective view of a cover kit according to the above preferred embodiment of the present invention, illustrating that the aesthetic pattern sheet is viewable from a rear side of a cover unit.

FIG. 3 is a method of producing an aesthetic pattern on a cover unit according to the above preferred embodiment of the present invention.

FIG. 4 is an alternative mode of the method of producing an aesthetic pattern on a cover unit according to the above preferred embodiment of the present invention.

### DETAILED DESCRIPTION OF THE PREFERRED EMBODIMENT

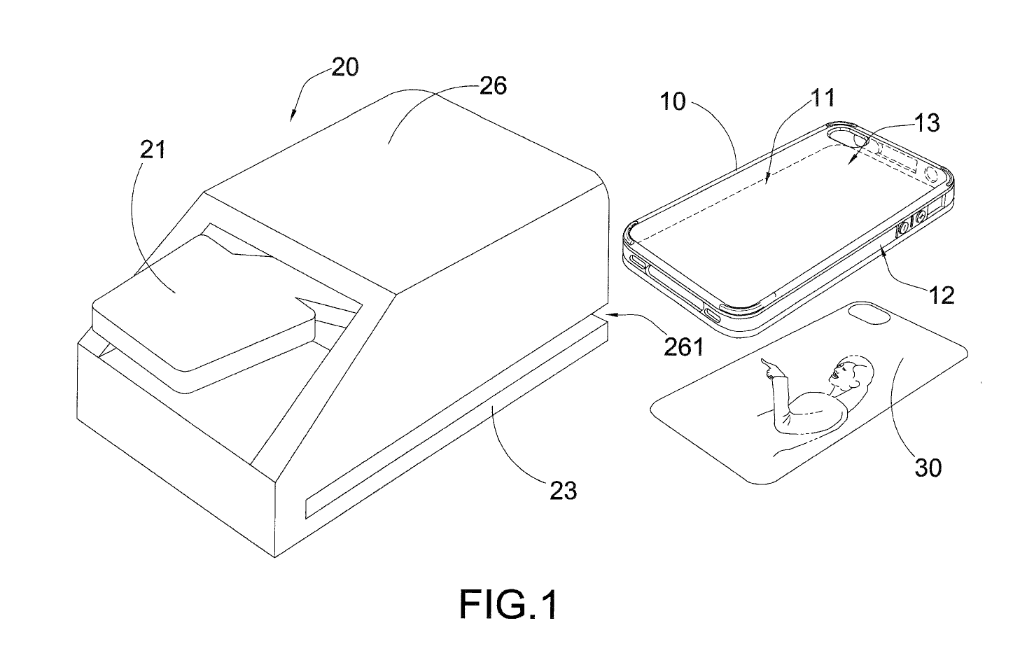

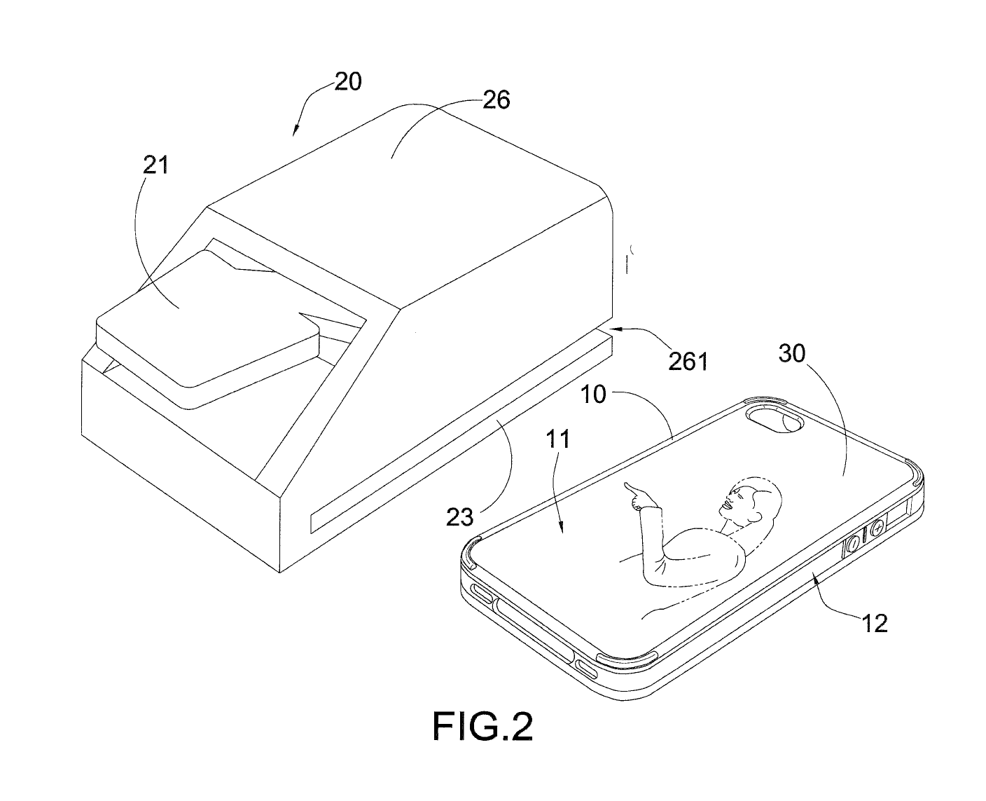

Referring to FIG. 1 to FIG. 2 of the drawings, a cover kit for a portable electronic device 70 according to a preferred embodiment of the present invention is illustrated, in which the cover kit comprises a cover unit 10 and a stamp unit 20.

The cover unit 10 has a transparent panel 11, a plurality of side boundary walls 12 peripherally extended from the transparent panel 11 to define a receiving cavity 13 between the transparent panel 11 and the side boundary walls 12, wherein the receiving cavity 13 is shaped and sized to fittedly and detachably receive the portable electronic device 70 therein.

The stamp unit 20 is adapted for cutting a predetermined printed material, such as a desirable magazine paper, to form an aesthetic pattern sheet 30, wherein the aesthetic pattern sheet 30 has a predetermined aesthetic pattern formed thereon, and is adapted for accommodating on the receiving cavity 13 in such a manner that the aesthetic pattern is capable of being observed from the transparent panel 11.

According to the preferred embodiment of the present invention, the cover unit 10 is preferably made of plastic material having the transparent panel 11 arranged to be in contact with a bottom surface of the portable electronic device. As such, when the aesthetic pattern sheet 30 is accommodated in the receiving cavity 13 in such a manner that the aesthetic pattern faces towards the transparent panel 11, people may observe the aesthetic pattern from an exterior of the cover unit 10 and through the transparent panel 11. Thus, although the transparent panel 11 does not have any aesthetic pattern formed thereon,

On the other hand, the stamp unit 20 is arranged to cut the printed material 80 into the aesthetic pattern sheet 30, which is sized and shaped to correspond to the transparent panel 11. More specifically, the stamp unit 20 comprises a stamping handle 21 having a predetermined cutting blade 22, a supporting base 23 movably mounted with respect to the stamping handle 21, wherein the printed materials is arranged to be placed on the supporting base 23 in such a manner that when the stamping handle 21 is depressed towards the supporting base 23, the cutting blade 22 is arranged to cut the printed materials into the aesthetic pattern sheet 30.

The stamp unit 20 further comprises a top cover 26 detachably mounted on top of the supporting base 23 to form a cutting slot 261 between the top cover 26 and the supporting base 23, wherein the printed material 80 is arranged to be inserted into the cutting slot 261 for being cut by the cutting blade 22.

Note that in order to cut the printed materials into a size which corresponds to the transparent panel 11, and to allow the user to see which portion of the printed materials is to be cut, the supporting base 23 further has a through cutting hole 231 formed thereon, whereas the stamp unit 20 further comprises a securing member 25 mounted on top of the supporting base 21, wherein the securing member 25 has a through slot 251 formed thereon and is aligned with the cutting hole 231 of the supporting base 23 for allowing the cutting blade 22 to fittedly pass through the cutting hole 231 and the through slot 251 for cutting the printed materials.

In other words, the printed materials is arranged to be placed on the securing member 25 and the user may locate the desirable aesthetic patter through observing the cutting hole 231 and the through slot 251. When the aesthetic pattern is accurately located in the stamp unit 20, the stamp unit 20 may be activated for cutting the printed materials to form the aesthetic pattern sheet.

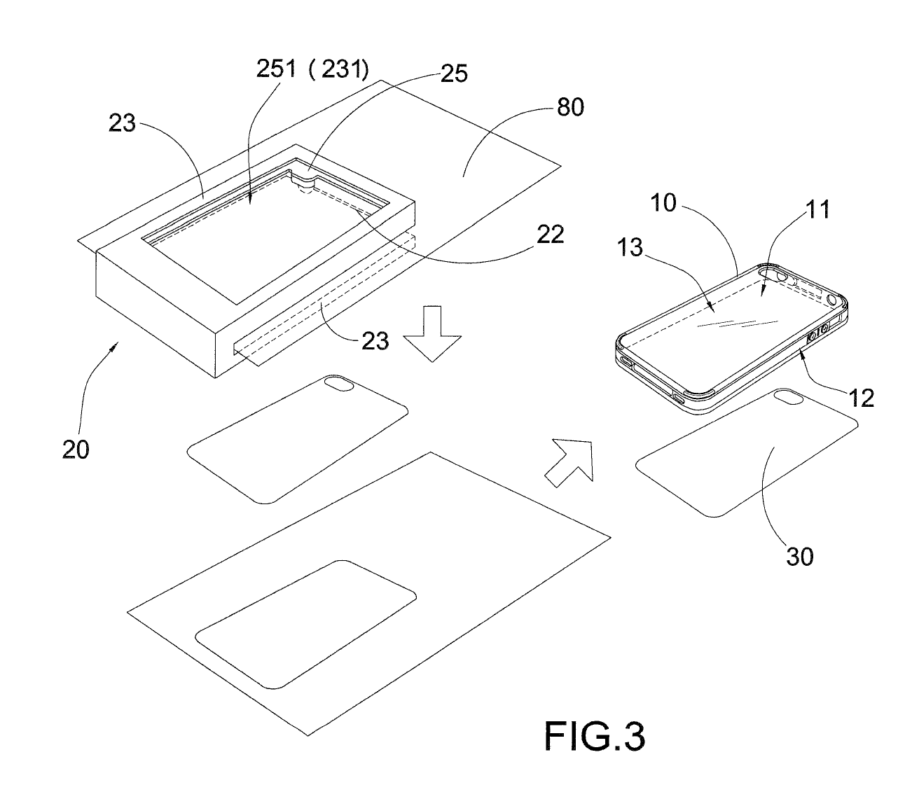

Referring to FIG. 3 of the drawings, a method of producing an aesthetic pattern on a cover unit according to a preferred embodiment of the present invention is illustrated, in which the method comprises the steps of:

(a) providing a predetermined piece of printed material 80 containing a predetermined aesthetic pattern;

(b) providing a cover unit 10 having a receiving cavity 13 and a transparent panel 11 formed as a sidewall of the receiving cavity 13;

(c) providing a stamp unit 20 having a stamping handle 21, a cutting blade 22, a supporting base 23 having a cutting hole 231 operatively mounted with respect to the stamping handle 21, a securing member 25 having a through slot 251, and a cutting slot 261 formed by a top cover 26 and the supporting base 23;

(d) putting the printed material 80 on the cutting slot 261;

(e) locating the aesthetic pattern through the cutting hole 231 and the through slot 251 which is aligned with the cutting hole 231;

(f) activating the stamping handle 21 so as to depress the cutting blade 22 for cutting the printed materials, wherein the cut portion of the printed materials forms an aesthetic pattern sheet 30; and

(g) detachably attaching the aesthetic pattern sheet 30 into receiving cavity 13 in such a manner that the aesthetic pattern faces towards the transparent panel 11 so as to allow the aesthetic pattern to be observed from an exterior of the cover unit 10.

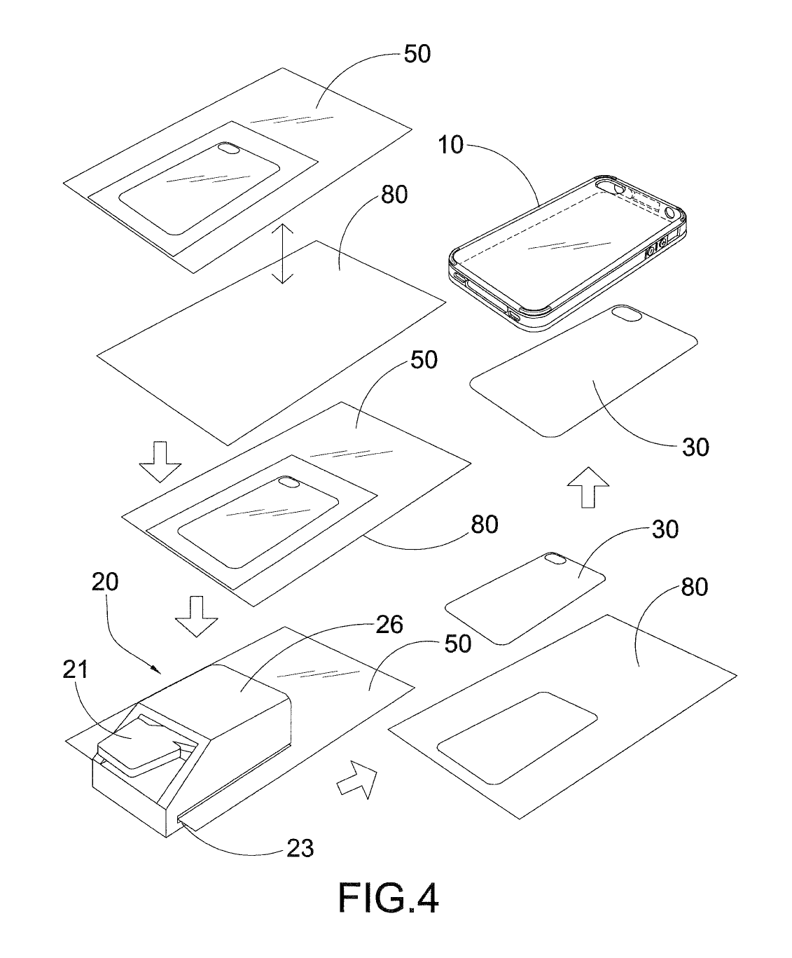

Referring to FIG. 4 of the drawings, a method of producing an aesthetic pattern on a cover unit according to an alternative mode of the preferred embodiment of the present invention is illustrated, in which the method comprises the steps of

(a′) providing a predetermined piece of printed material 80 containing a predetermined aesthetic pattern;

(b′) providing a predetermined of transparent sheet 50;

(c′) providing a cover unit 10 having a receiving cavity 13 and a transparent panel 11 formed as a sidewall of the receiving cavity 13;

(d′) providing a stamp unit 20 having a stamping handle 21, a cutting blade 22, a supporting base 23 having a cutting hole 231 operatively mounted with respect to the stamping handle 21, a securing member 25 having a through slot 251, and a cutting slot 261 formed by a top cover 26 and the supporting base 23;

(e′) producing a contour of the receiving cavity 13 and an exterior contour of the stamp unit 20 on the transparent sheet 50:

(f′) detachably attaching the transparent sheet 50 onto the printed materials 80;

(g′) putting the transparent sheet 50 and the printed materials 80 into the cutting slot 261;

(h′) activating the stamping handle 21 so as to depress the cutting blade 22 for cutting the printed materials 80, wherein the cut portion of the printed materials 80 forms an aesthetic pattern sheet 30; and

(i′) detachably attaching the aesthetic pattern sheet 30 into receiving cavity 13 in such a manner that the aesthetic pattern faces towards the transparent panel 11 so as to allow the aesthetic pattern to be observed from an exterior of the cover unit 10.

One skilled in the art will understand that the embodiment of the present invention as shown n the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims

What is claimed is:

1. A cover kit, comprising
a cover unit having a transparent panel, a plurality of side boundary walls peripherally extended from said transparent panel to define a receiving cavity between said transparent panel and said side boundary walls, wherein said receiving cavity is shaped and sized for fittedly and detachably receiving said portable electronic device; and
a stamp unit adapted for cutting a predetermined printed material to form aesthetic pattern sheet, wherein said aesthetic pattern sheet has a predetermined aesthetic pattern formed thereon, and is accommodated in said receiving cavity in such a manner that said aesthetic pattern is capable of being observed from said transparent panel.

2. The cover kit, as recited in claim 1, wherein said aesthetic pattern faces towards said transparent panel.

3. The cover kit, as recited in claim 1, wherein said cover unit is made of plastic material.

4. The cover kit, as recited in claim 3, wherein said stamp unit comprises a top cover detachably mounted on top of said supporting base to form a cutting slot between said top cover and said supporting base.

5. The cover recited in claim; 4, wherein said printed material is slidly inserted into said cutting slot.

6. The cover kit, as recited in claim said stamp unit comprises a stamping handle having a predetermined cutting blade to cut said printed material into said aesthetic pattern sheet.

7. The cover kit, as recited in claim 6, wherein said cutting blade is actuated when said stamping handle is downwardly pressed for cutting said printed material.

8. The cover kit, as recited in claim 6, wherein said supporting base comprises a through cutting hole formed thereon for said cutting blade fittedly passing through said through cutting hole in order to cut said printed material.

9. The cover kit, as recited in claim 8, wherein said stamp unit comprises a securing member mounted on top of said supporting base, wherein said securing member has a through slot formed thereon and is aligned with said through cutting hole of said supporting base for allowing said cutting blade to fittedly pass through said through cutting hole and said through slot for cutting said printed materials.

10. The cover kit, as recited in claim 1, wherein a rear surface of said portable electronic device within said receiving cavity of said cover unit is placed towards said transparent panel.

11. A method of producing an aesthetic pattern on a cover unit, comprising the steps of:
(a) providing a predetermined piece of printed material containing a predetermined aesthetic pattern;
(b) providing a cover unit having a receiving cavity and a transparent panel formed as a sidewall of said receiving cavity;
(c) providing a stamp unit having a stamping handle, a cutting blade, a supporting base having a cutting hole operatively mounted with respect to said stamping handle, a securing member having a through slot, and a cutting slot formed by a top cover and said supporting base;
(d) putting said printed material on said cutting slot;
(e) locating said aesthetic pattern through said cutting hole and said through slot which is aligned with said cutting hole;
(f) activating said stamping handle so as to depress said cutting blade for cutting said printed materials, wherein a cut portion of said printed materials forms an aesthetic pattern sheet; and
(g) detachably attaching said aesthetic pattern sheet into said receiving cavity in such a manner that said aesthetic pattern faces towards said transparent panel so as to allow said aesthetic pattern to be observed from an exterior of said cover unit.

12. The cover kit, as recited in claim 11, in step (f), wherein said stamping handle is pressed downwardly towards said supporting base for depress said cutting blade for cutting said printed materials.

13. The cover kit, as recited in claim 11, in step (d), wherein said printed material is slid to insert into said cutting slot.

14. A method of producing an aesthetic pattern on a cover unit, comprising the
(a) providing a predetermined piece of printed material containing predetermined aesthetic pattern;
(b) providing a predetermined of transparent sheet;
(c) providing a cover unit having a receiving cavity and a transparent panel formed as a sidewall of said receiving cavity;
(d) providing a stamp unit having a stamping handle, a cutting blade, a supporting base having a cutting hole operatively mounted with respect to said stamping handle, a securing member having a through slot, and a cutting slot formed by a top cover and said supporting base;
(e) producing a contour of said receiving cavity and an exterior contour of said stamp unit on said transparent sheet;
(f) detachably attaching said transparent sheet onto said printed materials;
(g) putting said transparent sheet and said printed materials into said cutting slot;
(h) activating said stamping handle so as to depress said cutting blade for cutting said printed materials, wherein the cut portion of said printed materials forms an aesthetic pattern sheet; and
(i′) detachably attaching said aesthetic pattern sheet into said receiving cavity in such a manner that said aesthetic pattern faces towards said transparent panel so as to allow said aesthetic pattern to be observed from an exterior of said cover unit.

15. The cover kit, as recited in claim 14, in step (h), wherein said stamping handle is pressed downwardly towards said supporting base for depress said cutting blade for cutting said printed materials.

16. The cover kit, as recited in claim 14, in step (g), wherein said printed material and said transparent sheet are slid to insert into said cutting slot.
